(19) United States
(12) Patent Application Publication
(10) Pub. No.: US 2005/0222366 A1
(43) Pub. Date: Oct. 6, 2005

(54) Process for preparing polyisocyanate prepolymers containing allophanate structural units

(75) Inventors: Michael Mager, Leverkusen (DE); Joachim Simon, Dusseldorf (DE); Malte Homann, Odenthal (DE)

Correspondence Address: BAYER MATERIAL SCIENCE LLC, 100 BAYER ROAD, PITTSBURGH, PA, 15205, US

(73) Assignee: Bayer MaterialScience AG

(21) Appl. No.: 11/087,462

(22) Filed: Mar. 23, 2005

(30) Foreign Application Priority Data
Apr. 1, 2004 (DE) 102004015982.3

(51) Int. Cl. C08G 18/28

(52) U.S. Cl. 528/73

(57) ABSTRACT

A method of preparing and stabilizing polyisocyanates that contain allophanate groups that are based on aliphatic and/or cycloaliphatic polyisocyanates. The method includes reacting a) one or more aliphatic and/or cycloaliphatic polyisocyanates with b) one or more polyhydroxy compounds to give an NCO-functional polyurethane prepolymer whose resultant urethane groups are reacted further with c) aliphatic and/or cycloaliphatic polyisocyanates, which may be different from those of a), and d) in the presence of catalysts and are thereby fully or partly allophanatized, and before, during and/or after the allophanatization, adding e) acidic additives. The polyisocyanates can be used in coatings, adhesive bonds or seals. Such coatings include the stabilized polyisocyanate prepolymers, at least one diol or polyol and/or at least one linear and/or cyclic, aliphatic, araliphatic and/or aromatic diamine or polyamine. The coatings can be used to coat substrates.

### CROSS REFERENCE TO RELATED PATENT APPLICATION

The present patent application claims the right of priority under 35 U.S.C. §119 (a)-(d) of German Patent Application No. 10 2004 015 982.3, filed Apr. 1, 2004.

### BACKGROUND OF THE INVENTION

1. Field of the Invention

The invention relates to a process for preparing polyisocyanate prepolymers containing allophanate structural units and to their use for preparing polyurethanes and polyureas.

2. Description of the Prior Art

Polyisocyanate prepolymers containing allophanate structural units are of particular interest on account of their high NCO content for comparatively low viscosity. They constitute useful crosslinkers for two-component polyurethane systems, and with blocked NCO groups can additionally be employed in one-component polyurethane systems. Polyurethane systems of this kind are used generally for producing coatings.

Allophanates based exclusively on aliphatic and/or cycloaliphatic isocyanates (“homoallophanates”) are of particular interest for the production of weather-resistant light-fast coatings.

Polyisocyanate prepolymers containing allophanate structural units are known in principle. Thus EP-A 0 682 012 describes prepolymers, including prepolymers based on diisocyanates and polyethers containing 1-4 hydroxyl groups, which can be reacted, using tin(II) compounds, with an excess of the diisocyanates to form the corresponding allophanates.

EP-A 712 840 describes the preparation of allophanates by reacting hydroxyl- and isocyanato-free urethanes with excess isocyanate, polyethers being among the possible OH-containing compounds on which the urethanes may be based. Thereafter the catalyst present can be removed or deactivated by catalyst poisoning, although no examples are given. The isocyanates used for the allophanatization are in every case different from those of the urethane groups.

EP-A 763 554 also starts from NCO- and OH-free urethanes, which are then allophanatized by reaction with diisocyanatohexylmethane isomers in the presence of catalysts. Catalyst deactivation or the use of stabilizing additives is not mentioned therein.

EP-A 769 511 discloses the preparation of heteroallophanates, where first of all an optionally NCO-functional urethane is formed from isocyanates with OH-functional compounds with an OH functionality of 1-1.5, some of which are based on polyether, and the urethane formed is subsequently allophanatized with aromatic isocyanates. Catalysts mentioned here, in unspecific lists, include numerous metal compounds based on zinc, tin, manganese, cobalt and nickel and also some mineral acids. Catalysts are deactivated by distillative removal or by the addition of water or acid chlorides. The preparation of allophanates based exclusively on aliphatic and/or cycloaliphatic diisocyanates is not described.

The processes described above, however, have the disadvantage that the NCO-functional allophanates thus obtainable lack sufficient stability, particularly in respect of their viscosity. During storage of the products there is a decrease in the NCO content and an increase in the viscosity. Since the said polyisocyanates containing allophanate structural units must generally be freed from excess diisocyanate after the allophanatization step, by means of thin-film evaporation at high temperatures (e.g. 160° C.), the aforementioned changes (in NCO content and viscosity) frequently arise even during the preparation.

It was an object of the present invention to provide a process for preparing polyisocyanate prepolymers containing allophanate structural units on the basis of linear aliphatic and/or cycloaliphatic polyisocyanates, which leads to products having markedly improved storage stability, especially improved stability of viscosity.

### SUMMARY OF THE INVENTION

The present invention is directed to a method of stabilizing polyisocyanates that contain allophanate groups that are based on aliphatic and/or cycloaliphatic polyisocyanates. The method includes adding compounds which are acidic according to the definition of Lewis or Brønsted, or of compounds which release such acids on reaction with water to a composition containing polyisocyanates that contain allophanate groups that are based on aliphatic and/or cycloaliphatic polyisocyanates.

The present invention is also directed to a process for preparing stabilized polyisocyanates containing allophanate groups that includes reacting
a) one or more aliphatic and/or cycloaliphatic polyisocyanates with
b) one or more polyhydroxy compounds to give an NCO-functional polyurethane prepolymer whose resultant urethane groups are reacted further with
c) aliphatic and/or cycloaliphatic polyisocyanates, which may be different from those of a), and
d) in the presence of catalysts
and are thereby fully or partly allophanatized, and before, during and/or after the allophanatization, and adding
e) acidic additives.

The present invention also provides coatings, adhesive bonds or seals that contain the above-described stabilized polyisocyanate prepolymers containing allophanate structural units.

The present invention further provides coating compositions containing one or more of the above-described stabilized polyisocyanate prepolymers containing allophanate structural units and at least one diol or polyol and/or at least one linear and/or cyclic, aliphatic, araliphatic and/or aromatic diamine or polyamine.

The present invention further provides substrates coated with coatings obtained from the above-described stabilized polyisocyanate prepolymers containing allophanate structural units.

### DETAILED DESCRIPTION OF THE INVENTION

Other than in the operating examples, or where otherwise indicated, all numbers or expressions referring to quantities of ingredients, reaction conditions, etc. used in the specification and claims are to be understood as modified in all instances by the term “about.” Surprisingly it has now been found that polyisocyanate prepolymers having such properties are obtained by adding acidic additives during and/or after the preparation of the stated products.

The invention accordingly provides for the use of compounds which are acidic according to the definition of Lewis or Brønsted, or of compounds which release such acids on reaction with water, for stabilizing polyisocyanates that contain allophanate groups and are based on aliphatic and/or cycloaliphatic polyisocyanates.

The present invention further provides a process for preparing stabilized polyisocyanates containing allophanate groups, wherein one or more aliphatic and/or cycloaliphatic polyisocyanates are reacted with one or more polyhydroxy compounds to give an NCO-functional polyurethane prepolymer whose resultant urethane groups are reacted further with aliphatic and/or cycloaliphatic polyisocyanates, which may be different from those of a), and catalysts and are thereby fully or partly allophanatized, and before, during and/or after the allophanatization, acidic additives are added. Further provided by the invention are the polyisocyanates obtainable by this process.

Suitable polyisocyanates of components a) and c) are the organic aliphatic and/or cycloaliphatic polyisocyanates that are known to the skilled person and have at least two isocyanate groups per molecule, and also mixtures thereof.

Examples of suitable aliphatic and cycloaliphatic polyisocyanates are di- or triisocyanates such as butane diisocyanate, pentane diisocyanate, hexane diisocyanate (hexamethylene diisocyanate, HDI), 4-isocyanatomethyl-1,8-octane diisocyanate (triisocyanatononane, TIN) or cyclic systems, such as 4,4′-methylenebis(cyclohexyl isocyanate), 3,5,5-trimethyl-1-isocyanato-3-isocyanatomethylcyclohexane(isophorone diisocyanate, IPDI) and also ω,ω′-diisocyanato-1,3-dimethylcyclohexane (H₆XDI).

Particular preference is given to the use in components a) and c) of hexane diisocyanate(hexamethylene diisocyanate, HDI), 4,4′-methylenebis(cyclohexyl isocyanate) and/or 3,5,5-trimethyl-1-isocyanato-3-isocyanatomethylcyclohexane (isophorone diisocyanate, IPDI) as polyisocyanates. One especially preferred polyisocyanate is HDI.

It is preferred to use the same polyisocyanates in a) and c).

As polyhydroxy compounds of component b) it is possible to use any polyhydroxy compounds known to the skilled worker, preferably with an average OH functionality >1.5. These may be, for example, low molecular weight diols (e.g. 1,2-ethanediol, 1,3- and/or 1,2-propanediol, 1,4-butanediol), triols (e.g. glycerol, trimethylolpropane) and tetraols (e.g. pentaerythritol), polyetherpolyols, polyesterpolyols, polycarbonatepolyols and polythioetherpolyols. Preferred polyhydroxy compounds are polyether-based substances of the aforementioned kind.

Preferably these polyetherpolyols have number-average molecular weights Mₙ of from 300 to 20 000 g/mol, more preferably 1000 to 12 000, very preferably 2 000 to 6 000 g/mol.

Additionally they preferably possess an average OH functionality of >1.9, more preferably >1.95.

The average functionality of the polyetherpolyols of component b) is preferably <8, more preferably <6, very preferably <4.

Polyetherpolyols of this kind are obtainable conventionally by alkoxylating suitable starter molecules with base catalysis or by using double metal cyanide (DMC) compounds.

Particularly suitable polyetherpolyols of component b) are those of the aforementioned kind which contain less than or equal to 0.02 milliequivalent of unsaturated end groups per gram of polyol (meq/g), preferably less than or equal to 0.015 meq/g, more preferably less than or equal to 0.01 meq/g (method of determination: ASTM D2849-69).

Polyetherpolyols of this kind have a particularly narrow molecular weight distribution, i.e. a polydispersity (PD=M_{w}/Nₙ) of from 1.0 to 1.5 and/or an OH functionality ≧1.9. Preferably the said polyetherpolyols have a polydispersity of from 1.0 to 1.5 and an OH functionality of more than 1.9, more preferably greater than or equal to 1.95.

Polyetherpolyols of this kind are preparable conventionally by alkoxylating suitable starter molecules using double metal cyanide catalysts (DMC catalysis). This is described for example in U.S. Pat. No. 5,158,922 (e.g. Example 30) and EP-A 0 654 302 (p. 5 line 26 to p. 6 line 32).

Examples of suitable starter molecules for preparing polyetherpolyols include simple, low molecular weight polyols, water, organic polyamines having at least two N—H bonds or any desired mixtures of such starter molecules. Alkylene oxides suitable for the alkoxylation are, in particular, ethylene oxide and/or propylene oxide, which for the alkoxylation may be used in either order or else in a mixture. Preferred starter molecules for preparing polyetherpolyols by alkoxylation, especially by the DMC method, are simple polyols such as ethylene glycol, propylene 1,3-glycol and butane-1,4-diol, hexane-1,6-diol, neopentyl glycol, 2-ethylhexane-1,3-diol, glycerol, trimethylolpropane, pentaerythritol and also low molecular weight, hydroxyl-containing esters of such polyols with dicarboxylic acids, or low molecular weight ethoxylation or propoxylation products of such simple polyols, or any desired mixture of such polyhydroxy compounds. The polyurethane prepolymers containing isocyanate groups are prepared by reacting the polyhydroxy compounds of component b) with excess amounts of the polyisocyanates from a). The reaction takes place in general at temperatures of from 20 to 140° C., preferably at 40 to 100° C., with or without the use of catalysts known per se from polyurethane chemistry, such as tin soaps, e.g. dibutyltin dilaurate, or tertiary amines, e.g. triethylamine or diazabicyclooctane.

The allophanatization then takes place subsequently by reaction of the polyurethane prepolymers containing isocyanate groups with polyisocyanates c), which may be identical to or different from those of component a), with the addition of suitable catalysts d) for the allophanatization. Typically thereafter, for the purpose of stabilization, the acidic additives of component e) are added and excess polyisocyanate is removed from the product by means for example of thin-film distillation or extraction.

The molar ratio of the OH groups of the compounds of component b) to the NCO groups of the polyisocyanates from a) and c) is preferably 1:1.5 to 1:20, more preferably 1:2 to 1:15, very preferably 1:5 to 1:15.

Examples of suitable catalysts d) for the allophanatization are zinc, tin and zirconium compounds, preference being given to using zinc compounds and tin compounds. Particularly preferred tin compounds and zinc compounds are tin(II) salts such as, for example, the Sn(II) dihalides, tin soaps or zinc soaps such as Sn(II) bis(2-ethylhexanoate), Sn(II) bis(n-octoate), Zn(II) bis(2-ethylhexanoate) and Zn(II) bis(n-octoate), and also organotin compounds. Especial preference is given to Zn(II) bis(2-ethylhexanoate).

These allophanatization catalysts are used typically in amounts of up to 5% by weight, based on the overall reaction mixture. It is preferred to use 5 to 500 ppm of the catalyst, more preferably 20 to 200 ppm.

As acidic additives of component e) it is possible to use Lewis acids (electron deficiency compounds) or Brønsted acids (protic acids) or compounds which release such acids on reaction with water.

These may be, for example, organic or inorganic acids or else neutral compounds such as acid halides or esters which react with water to form the corresponding acids. Mention may be made here in particular of hydrochloric acid, phosphoric acid, phosphoric esters, benzoyl chloride, isophthaloyl dichloride, p-toluenesulphonic acid, formic acid, acetic acid, dichloroacetic acid and 2-chloropropionic acid.

Particular preference is given to the use of acid halides, especially benzoyl chloride or isophthaloyl dichloride, as acidic additives.

The acidic additives are generally added at least in an amount such that the molar ratio of the acidic centres of the acidic additives to the catalytically active centres of the catalyst is at least 1:1. Preference, however, is given to adding an excess of the acidic additive.

Thin-film distillation is the preferred method of separating off excess diisocyanate, and it is generally practised at temperatures from 100 to 160° C. under a pressure of from 0.01 to 3 mbar. The residual monomer content thereafter is preferably less than 1% by weight, more preferably less than 0.5% by weight (diisocyanate).

The entirety of the process steps can be carried out if desired in the presence of inert solvents. By inert solvents in this context are meant those which do not react with the reactants under the given reaction conditions. Examples are ethyl acetate, butyl acetate, methoxypropyl acetate, methyl ethyl ketone, methyl isobutyl ketone, toluene, xylene, aromatic or (cyclo)aliphatic hydrocarbon mixtures or any desired mixtures of such solvents. With preference, however, the reactions according to the invention are carried out solventlessly.

The components involved may be added in any order both in the case of the preparation of the prepolymers containing isocyanate groups and in the case of allophanatization. It is nevertheless preferred to add the polyetherpolyol b) to the initially introduced polyisocyanate of components a) and c) and finally to add the allophanatization catalyst d).

In one preferred embodiment of the invention the polyisocyanates of components a) and c) are charged to a suitable reaction vessel and heated at 40 to 100° C., with stirring where appropriate. After the desired temperature has been reached the polyhydroxy compounds of component b) are then added, with stirring, and stirring is continued until the NCO content is at or just below the theoretical NCO content of the polyurethane prepolymer to be expected in accordance with the chosen stoichiometry. At that point the allophanatization catalyst d) is added and the reaction mixture is heated at 50 and 100° C. until the NCO content is at or just below the level desired. Following the addition of the acidic additives of component e) as stabilizers the reaction mixture is cooled or passed directly to the thin-film distillation procedure. There the excess polyisocyanate is separated off at temperatures from 100 to 160° C. under a pressure of from 0.01 to 3 mbar down to a residual monomer content of less than 1%, preferably less than 0.5%. Following the thin-film distillation it is possible if desired to add further stabilizer.

The allophanates formed in the present process typically correspond to the general formula (I), 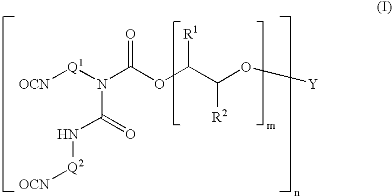
in which
Q¹ and Q² independently of one another are the radical of a linear and/or cyclic aliphatic diisocyanate of the stated type, preferably —(CH₂)₆—,
R¹ and R² independently of one another are hydrogen or a C₁-C₄ alkyl radical,
R¹ and R² preferably being hydrogen and/or methyl groups,
Y is the radical of a starter molecule of the stated type having a functionality of from 2 to 6, and hence
n is a value from 2 to 6, which as a result of the use of different starter molecules need not of course be an integer, and
m preferably corresponds to a number of monomer units such that the average molecular weight of the polyether on which the structure is based is 300 to 20000 g/mol.

The allophanates obtained are preferably of the general formula (II) 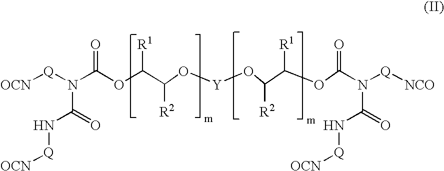
in which
Q is the radical of a linear and/or cyclic aliphatic diisocyanate of the stated type, preferably —(CH₂)₆—,
R¹ and R² independently of one another are hydrogen or a C₁-C₄ alkyl radical,
R¹ and R² preferably being hydrogen and/or methyl groups,
Y is the radical of a difunctional starter molecule of the stated type and
m corresponds to a number of monomer units such that the number-average molecular weight of the polyether on which the structure is based is 300 to 20000 g/mol.

The allophanates stabilized in accordance with the invention typically have weight-average molecular weights of from 700 to 50000 g/mol, preferably 1500 to 15000 g/mol and more preferably 1500 to 8000 g/mol.

The allophanates stabilized in accordance with the invention typically have viscosities at 23° C. of from 500 to 100000 mPas, preferably 500 to 50000 mPas, more preferably from 1000 to 7500 mPas, and very preferably from 1000 to 3500 mPas.

The products obtainable by the process of the invention are notable in particular for the stability of their viscosity. With appropriate stabilization the increase in viscosity after 7 days' storage at 50° C. is less than 10%.

The allophanates stabilized in accordance with the invention can be used for example for preparing polyurethanes, polyureas or polyurethane-ureas, by reacting them with suitable polyols or polyamines, respectively, or else with a mixture of both. This reaction may take place at room temperature or below, or else at elevated temperatures (baking). The polyurethanes or polyureas thus obtained are in turn of particular suitability as a coating.

The invention accordingly further provides coating compositions comprising one or more of the allophanates stabilized in accordance with the invention and at least one diol or polyol and/or at least one linear and/or cyclic, aliphatic, araliphatic and/or aromatic diamine or polyamine.

The allophanates prepared by the process of the invention are notable for their very high compatibility with the aforementioned components B) and C). The combination of A) and C) in particular results in homogeneous (polyurea) coatings.

The coating compositions referred to can be applied to surfaces by the conventional techniques such as spraying, dipping, flow coating or pouring. After flashing off to remove any solvents present, the coatings then cure under ambient conditions or else at elevated temperatures of, for example, from 40 to 200° C.

The aforementioned coating compositions can be applied for example to metals, plastics, ceramic, glass and natural substances, it being possible for the said substrates to have been subjected to any pretreatment that may be necessary.

### EXAMPLES

Unless mention is made to the contrary, all percentages should be understood as being per cent by weight.

The NCO contents were determined by back-titrating excess added di-n-butylamine with hydrochloric acid.

The viscosities were determined at 23° C. using a rotational viscometer from Haake.

The colour number was determined in accordance with DIN EN 1557 (Hazen).

### Comparative Example 1

344.4 g of 1,6-hexane diisocyanate were heated to 100° C. with stirring. Then, over the course of about 3 hours, 405.5 g were added of a polypropylene glycol which had been prepared by means of DMC catalysis (base-free) (unsaturated groups content <0.01 meq/g, molar weight 2000 g/mol, OH number 56 mg KOH/g, theoretical functionality 2). The reaction mixture was thereafter heated at 100° C. until an NCO content of 20.7% was reached. Then the temperature was lowered to 80° C. and 60 mg of zinc(II) bis(2-ethylhexanoate) were added. After stirring at 80° C. for about 3 hours a further 60 mg of zinc(II) bis(2-ethylhexanoate) were added and the reaction mixture was again heated at 100° C. for an hour (NCO content 20.0%). Thereafter the reaction mixture was cooled to room temperature and left to stand for 20 h. The NCO content thereafter, at 15.5%, was well below the theoretical value of 18.4%; in other words, numerous NCO groups had been consumed by secondary reactions. The product was discarded.

### Comparative Example 2

223.8 g of 1,6-diisocyanathexane (HDI) were heated to 100° C. while stirring under nitrogen. Then, 175.7 g of a polypropylene glycol produced by DMC catalysed (base-free) polymerisation of propylene oxide (OH number 56 mg KOH/g polyol, number average molecular weight 2000 g/mol, theoretical functionality: 2) were added within about 3 h and the reaction mixture was kept at 100° C. until a NCO content of 26.0% was obtained. Now, the reaction temperature was adjusted to 90° C. and then 0.48 g of the catalyst Zn(II)bis(2-ethylhexanoate) wad added as a 10 wt. % solution in n-butylacetate. After about 2 h and 30 min stirring at 90° C. a NCO content of 23.8 % was obtained (theory: 24.2 %). After additional 2 h at 90° C. (NCO content 21.7 %) and then leaving the reaction mixture at room temperature (about 16 h), the NCO content significantly felt to 20.9 %.

### Example 1

344.4 g of 1,6-hexane diisocyanate were heated to 100° C. with stirring. Then, over the course of about 3 hours, 405.5 g were added of a polypropylene glycol which had been prepared by means of DMC catalysis (base-free) (unsaturated groups content <0.01 meq/g, molar weight 2000 g/mol, OH number 56 mg KOH/g, theoretical functionality 2). The reaction mixture was thereafter heated at 100° C. until an NCO content of 20.7% was reached. Then 60 mg of zinc(II) bis(2-ethylhexanoate) were added and the reaction mixture was heated at 100° C. until an NCO content of 18.4% was reached. Following the addition of 80 mg of dibutyl phosphate the NCO content remained constant (18.2%) and the excess 1,6-hexane diisocyanate was removed by means of thin-film distillation at about 0.5 mbar and 140° C.

This gave a clear, colourless product having an NCO content of 5.75% and a viscosity of 3360 mPas (23° C.).

### Example 2

275.5 g of 1,6-hexane diisocyanate were first admixed with 120 mg of a 10% strength solution of isophthaloyl dichloride in n-butyl acetate, and thereafter the mixture was heated to 100° C. with stirring. Then, over the course of about 3 hours, 324.3 g were added of a polypropylene glycol which had been prepared by means of DMC catalysis (base-free) (unsaturated groups content <0.01 meq/g, molar weight 2000 g/mol, OH number 56 mg KOH/g, theoretical functionality 2). The reaction mixture was thereafter heated at 100° C. until an NCO content of 20.7% was reached. Then the temperature was lowered to 90° C. and, following the addition of 50 mg of zinc(II) bis(2-ethylhexanoate), the reaction mixture was stirred until the NCO content was 18.4%. Following the addition of 50 mg of isophthaloyl dichloride the NCO content remained virtually constant (18.5%) and the excess 1,6-hexane diisocyanate was removed by means of thin-film distillation at about 0.5 mbar and 140° C.

This gave a clear, colourless product having an NCO content of 5.75% and a viscosity of 3360 mPas (23° C.).

### Example 3

In the same way as in Example 1, 275.5 g of 1,6-hexane diisocyanate and 324.3 g of a polypropylene glycol were reacted in the presence of 50 mg of zinc(II) bis(2-ethylhexanoate) and the reaction product was stabilized, prior to the thin-film distillation, with 50 mg of isophthaloyl dichloride, albeit with the difference that no addition of isophthaloyl dichloride was made to the 1,6-hexane diisocyanate.

### Example 4

275.5 g of 1,6-hexane diisocyanate were first admixed with 120 mg of a 10% strength solution of isophthaloyl dichloride in n-butyl acetate, and thereafter the mixture was heated to 100° C. with stirring. Then, over the course of about 3 hours, 327.9 g were added of a polypropylene glycol which had been obtained by means of base-catalysed propylene oxide polymerization (molar weight 2000 g/mol, OH number 56 mg KOH/g, theoretical functionality 2). The reaction mixture was thereafter heated at 100° C. until an NCO content of 20.7% was reached. Then the temperature was lowered to 90° C. and, following the addition of 50 mg of zinc(II) bis(2-ethylhexanoate), the reaction mixture was stirred until the NCO content was 18.4%. Following the addition of 50 mg of isophthaloyl dichloride the excess 1,6-hexane diisocyanate was removed by means of thin-film distillation at about 0.5 mbar and 140° C.

This gave a clear product having an NCO content of 5.07% and a viscosity of 2180 mPas (23° C.).

### Example 5

In the same way as in Example 3, 275.5 g of 1,6-hexane diisocyanate and 324.4 g of a polypropylene glycol were reacted in the presence of 50 mg of zinc(II) bis(2-ethylhexanoate) and the reaction product was stabilized, prior to the thin-film distillation, with 50 mg of isophthaloyl dichloride, albeit with the difference that no addition of isophthaloyl dichloride was made to the 1,6-hexane diisocyanate.

This gave a clear product having an NCO content of 5.75% and a viscosity of 4230 mPas (23° C.).

### Example 6

336.0 g of 1,6-hexane diisocyanate were first admixed with 120 mg of a 10% strength solution of isophthaloyl dichloride in n-butyl acetate, and thereafter the mixture was heated to 100° C. with stirring. Then, over the course of about 3 hours, 263.8 g were added of a polypropylene glycol which had been prepared by means of DMC catalysis (base-free) (unsaturated groups content <0.01 meq/g, molar weight 2000 g/mol, OH number 56 mg KOH/g, theoretical functionality 2). The reaction mixture was thereafter heated at 100° C. until an NCO content of 26.1% was reached. Then the temperature was lowered to 90° C. and, following the addition of 50 mg of zinc(II) bis(2-ethylhexanoate), the reaction mixture was stirred until the NCO content was 24.3%. Following the addition of 50 mg of isophthaloyl dichloride the excess 1,6-hexane diisocyanate was removed by means of thin-film distillation at 0.6 mbar and 140° C.

This gave a clear, colourless product having an NCO content of 6.45% and a viscosity of 2860 mPas (23° C.).

### Example 7

50 g of the allophanate prepared according to Example 2 were stored in a tightly sealed glass bottle at 50° C. in a drying cabinet. As can be seen from the values below, the viscosity during this storage period rose only slightly (<8%), with virtually no decrease in the NCO content (<2.1%):

Allophanate from Example 2

| | 0 days | 7 days | 14 days |
|---|---|---|---|
| NCO content [%] | 5.75 | 5.71 | 5.63 |
| Viscosity (23° C.) [mPas]: | 3360 | 3440 | 3620 |

Although the invention has been described in detail in the foregoing for the purpose of illustration, it is to be understood that such detail is solely for that purpose and that variations can be made therein by those skilled in the art without departing from the spirit and scope of the invention except as it may be limited by the claims.

### Example 8

10 mg of isophtalolyl dichloride were added to 223,8 g of 1,6-diisocyanatohexane (HDI) and heated to 100° C. while stirring under nitrogen. Then, 175.7 g of a polypropylene glycol produced by DMC catalysed (base-free) polymerisation of propylene oxide (OH number 56 mg KOH/g polyol, number average molecular weight 2000 g/mol, theoretical functionality: 2) were added within about 3 h and the reaction mixture was kept at 100° C. until a NCO content of 26.1% was obtained. Now, the reaction temperature was adjusted to 90° C. and then 0.48 g of the catalyst Zn(II)bis(2-ethylhexanoate) wad added as a 10 wt. % solution in n-butylacetate. After about 2 h and 30 min stirring at 90° C. a NCO content of 24.1% was obtained (theory: 24.2%) and finally 50 mg of isophtaloyl dichloride were added. After additional 2 h at 90° C. (NCO content 23.8%) and then leaving the reaction mixture at room temperature (about 16 h), the NCO content was maintained at 23.8%.

After addition of the acidic additive, a significantly more stable prepolymer is obtained (see comparative example 2).

1. A method of stabilizing polyisocyanates that contain allophanate groups that are based on aliphatic and/or cycloaliphatic polyisocyanates comprising adding compounds which are acidic according to the definition of Lewis or Brønsted, or of compounds which release such acids on reaction with water to a composition comprising polyisocyanates that contain allophanate groups that are based on aliphatic and/or cycloaliphatic polyisocyanates

2. A process for preparing stabilized polyisocyanates containing allophanate groups, comprising reacting
a) one or more aliphatic and/or cycloaliphatic polyisocyanates with
b) one or more polyhydroxy compounds to give an NCO-functional polyurethane prepolymer whose resultant urethane groups are reacted further with
c) aliphatic and/or cycloaliphatic polyisocyanates, which may be different from those of a), and
d) in the presence of catalysts and are thereby fully or partly allophanatized, and before, during and/or after the allophanatization, and adding
e) acidic additives.

3. The process for preparing stabilized polyisocyanate prepolymers containing allophanate structural units according to claim 2, wherein polyisocyanates of the same type are used in components a) and c).

4. The process for preparing stabilized polyisocyanate prepolymers containing allophanate structural units according to claim 2, wherein hexamethylene diisocyanates are used as polyisocyanates in components a) and c).

5. The process for preparing stabilized polyisocyanate prepolymers containing allophanate structural units according to claim 2, wherein polyetherpolyols are used in component b).

6. The process for preparing stabilized polyisocyanate prepolymers containing allophanate structural units according to claim 2, wherein hydrochloric acid, benzoyl chloride, isophthaloyl dichloride, p-toluenesulphonic acid, formic acid, acetic acid, dichloroacetic acid, 2-chloropropionic acid or mixtures thereof with one another are used as acidic additives in component e).

7. Stabilized polyisocyanate prepolymers containing allophanate structural units obtained according to the process according to claim 2.

8. Coatings, adhesive bonds or seals comprising the stabilized polyisocyanate prepolymers containing allophanate structural units according to claim 7.

9. Coating compositions comprising one or more stabilized polyisocyanate prepolymers containing allophanate structural units according to claim 7 and at least one diol or polyol and/or at least one linear and/or cyclic, aliphatic, araliphatic and/or aromatic diamine or polyamine.

10. Substrates coated with coatings obtained from stabilized polyisocyanate prepolymers containing allophanate structural units according to claim 7.

11. The process for preparing stabilized polyisocyanate prepolymers containing allophanate structural units according to claim 3, wherein hexamethylene diisocyanates are used as polyisocyanates in components a) and c).

12. The process for preparing stabilized polyisocyanate prepolymers containing allophanate structural units according to claim 3, wherein polyetherpolyols are used in component b).

13. The process for preparing stabilized polyisocyanate prepolymers containing allophanate structural units according to claim 3, wherein hydrochloric acid, benzoyl chloride, isophthaloyl dichloride, p-toluenesulphonic acid, formic acid, acetic acid, dichloroacetic acid, 2-chloropropionic acid or mixtures thereof with one another are used as acidic additives in component e).

14. Stabilized polyisocyanate prepolymers containing allophanate structural units obtained according to the process according to claim 3.

15. Coatings, adhesive bonds or seals comprising the stabilized polyisocyanate prepolymers containing allophanate structural units according to claim 14.

16. Coating compositions comprising one or more stabilized polyisocyanate prepolymers containing allophanate structural units according to claim 14 and at least one diol or polyol and/or at least one linear and/or cyclic, aliphatic, araliphatic and/or aromatic diamine or polyamine.

17. The process for preparing stabilized polyisocyanate prepolymers containing allophanate structural units according to claim 4, wherein polyetherpolyols are used in component b).

18. The process for preparing stabilized polyisocyanate prepolymers containing allophanate structural units according to claim 4, wherein hydrochloric acid, benzoyl chloride, isophthaloyl dichloride, p-toluenesulphonic acid, formic acid, acetic acid, dichloroacetic acid, 2-chloropropionic acid or mixtures thereof with one another are used as acidic additives in component e).

19. Stabilized polyisocyanate prepolymers containing allophanate structural units obtained according to the process according to claim 4.

20. Coating compositions comprising one or more stabilized polyisocyanate prepolymers containing allophanate structural units according to claim 19 and at least one diol or polyol and/or at least one linear and/or cyclic, aliphatic, araliphatic and/or aromatic diamine or polyamine.
